(19) United States
(12) Patent Application Publication
(10) Pub. No.: US 2003/0220928 A1
(43) Pub. Date: Nov. 27, 2003

(54) Method for organizing and querying a genomic and proteomic databases

(76) Inventors: Patrick Durand, Paris (FR); Jerome Wojcik, Paris (FR); Vincent Schachter, Paris (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/154,228

(22) Filed: May 21, 2002

(51) Int. Cl. G06F 17/00

(52) U.S. Cl. 707/100

(57) ABSTRACT

A method for organizing genomic and proteomic information in a database having a plurality of data nodes and a plurality of links capable of binding data nodes two by two, genomic and proteomic information being stored in a plurality of independent databases and an access method to access by query the contents of a database organized by the preceding organization method for a defined query. The method uses the steps of: a) organizing of the query in the form of a graph pattern having a plurality of nodes and a plurality of links binding the nodes two by two, the nodes and the links being taken in the set of data node types and links types respectively of the organized database: b) seeking the database of a set of nodes and links whose type corresponding to the query thus organized, the set of nodes and links forming a set of occurrences of the graph pattern; c) provisioning the terminal with the nodes and links.

The invention relates to a method to organize genomic and proteomic databases and to access by query to these databases.

Currently, a genome comprises a huge mass of data organized in a plurality of independent databases. A user, that searches particular information in this mass of data, is quickly lost and overloaded. He must query databases one after the other without knowing if he will be able to connect between them these different sources of information.

By this way, there is a need for a bioinformatic tool to provide a database organization of the mass of information concerning genomes and to integrate in a simple way for a user data provided by the different external databases.

And there is a need to provide a method to access by query to data thus organized.

To this end, the present invention provides a method to organize genomic and proteomic information in a organized database having a plurality of data nodes and a plurality of links capable to bind data nodes two by two, genomic and proteomic information being stored in a plurality of independent databases, the method being capable to be implemented by a processor capable to access a plurality of memorizing means containing the plurality of independent databases respectively and to storage means containing the organized database, wherein the method comprises steps of:

a) gathering data from the plurality of independent databases concerning at least one genome,

b) determining from the data thus gathered a set of data node types with biological entities/concepts data and a set of link types with biological links/interactions data,

c) organizing in a hierarchical way the set of data node types and the set of link types,

d) organizing data thus gathered in the plurality of data nodes and the plurality of links associated with their respective data node or link type,

e) storing in the organized database the hierarchical organized sets of data node types and of link types and organized data.

Thus, the method gathers in one organized database the whole mass of information concerning at least one genome. The organized database containing several types of data nodes and links can be represented as a single composite graph (as mixed composite ones), simplifying the navigation of the user through it.

Advantageously but optionally, the method presents at least one of the following additional features:

in step c, each type presents at least one attribute,

in step c, a child type inherits of all the attributes of his father type,

in step c, a root type is created comprising a set of attributes common to all other type in the considered set,

in step c, a father type is created for a group of child types having a set of attributes in common,

in step d, two data nodes of a first and a second data node types respectively connected by a first link of a first type link are capable of being connected by a second link of another second link type,

the second link type is a son or a father of the first link type,

two data nodes of types sons of the first and the second data node types respectively are capable of being connected by a link of the first link type or of a type son of the link type.

The present invention provides also a system comprising a processor capable to access a plurality of memorizing means containing the plurality of independent databases respectively and to storage means containing the organized database, characterized in that it is capable to implement the method presenting at least one of the previous cited features.

The present invention provides also an access method by query, from a data consultation terminal, to the contents of a database organized by a organizing method presenting at least one of the previous cited features, the access method being capable to be implemented by a processor capable to access storing means containing the organized database, wherein the access method comprises, for a defined query, steps of:

a) organizing of the query in the form of a graph pattern comprising a plurality of nodes and a plurality of links binding the nodes two by two, the nodes and the links being taken in the set of data node types and links types respectively of the organized database;

b) seeking in the organized database of a set of data nodes and links whose types corresponding to the said query thus organized, the said set of data nodes and links forming a set of occurrences of the graph pattern;

c) provisioning the terminal with the said set of data nodes and links.

Thus, the method makes it possible to seek not only data contained in nodes of the organized database but also to seek particular relations well defined between the nodes. That makes it possible to seek information on structures of complex graphs as mixed composite type ones. Moreover, the organization of the query in the form of a graph having the same complexity makes it possible to simplify its development and to facilitate search in the database.

Advantageously but optionally, the access method according to the invention presents at least one of the following additional features:

in step b), the method comprises the following steps:

b1) determining a graph sub-pattern of the graph pattern comprising only one link binding two nodes, the link being selected among the plurality of links of the graph pattern;

b2) searching in the organized database a set of occurrences of the graph sub-pattern thus determined;

b3) selecting a link among the possible links binding the nodes of the previous graph sub-pattern to nodes of the graph pattern not comprised in the previous graph sub-pattern;

b4) determining a new graph sub-pattern comprising the previous graph sub-pattern, the link sought at the time of the previous step and the node that this link connects to one of the nodes of the previous graph sub-pattern;

b5) searching in the organized database of a new set of occurrences of the new graph sub-pattern thus determined from the previous set of occurrences;

b6) while the new graph sub-pattern is not the graph pattern, repeating the steps b3 to b5, the new graph sub-pattern becoming then the previous graph sub-pattern and the new set of occurrences, the previous set of occurrences;

in step b1), the link being selected has the lowest number of occurrences of links in the organized database,

in step b3), the link selected has the lowest number of occurrences of links in the organized database,

in step a), each node of the graph pattern is modeled by a variable exclusive to said node;

in the step a), each link of the graph pattern is modeled by a variable exclusive to said link;

the exclusive variable of link is associated in an indissociable way to two variables of nodes modeling the two nodes of the graph pattern bound by the link modeled by the variable of link considered;

the query is directly defined in the form of a graph pattern;

in step c), the provision is carried out in the form of a table of data nodes and links whose each line corresponds to an occurrence in the organized database of the graph pattern;

in step c), for each occurrence of the graph pattern found, the method enriches the data of the occurrence considered by indicating the existence of possible data nodes of the organized database, called neighbors, connected directly to the data nodes of said occurrence;

during enrichment, the method indicates for each data node of the occurrence considered, the number of possible neighbor data nodes; and,

the method indicates, for each possible neighbor data node, information concerning the link that connects it to the data node considered of the occurrence considered.

The present invention provides also a system comprising a processor capable to access storing means containing the organized database, characterized in that it is capable to implement the access method having at least one of the previous cited features.

Other characteristics and advantages of the invention will appear with the reading of detailed description, hereafter, of a mode of realization. On the annexed drawings:

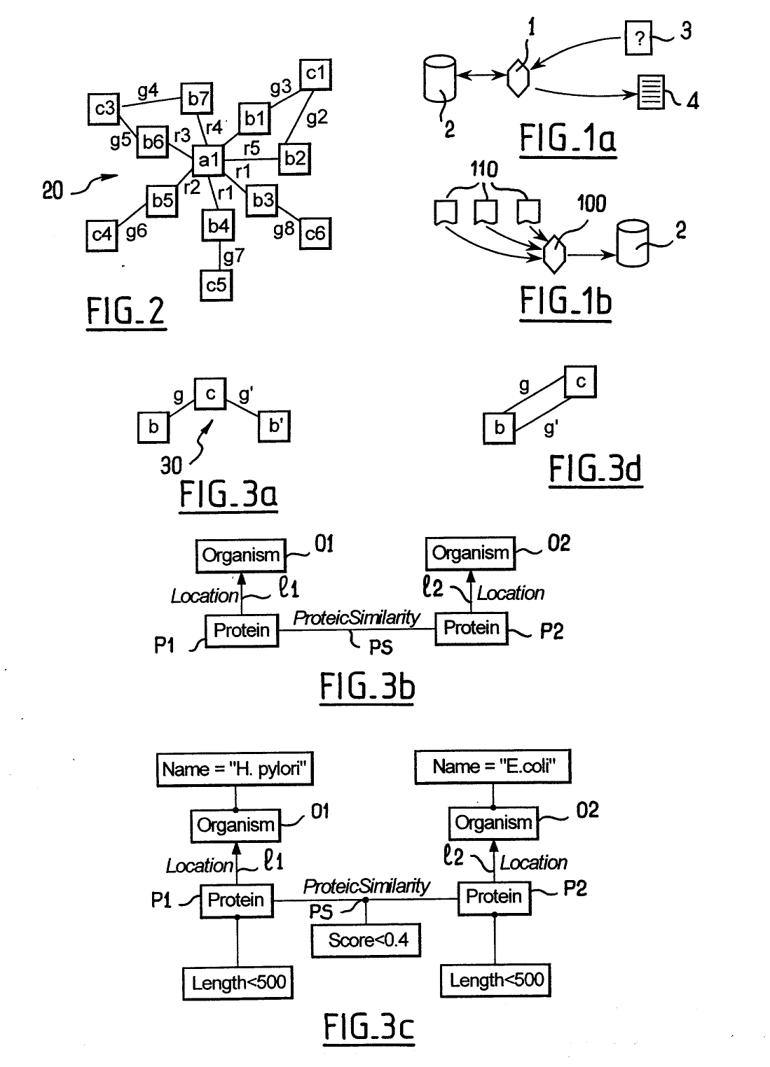

FIG. 1a is a schematic representation of the organization method according to the invention,

FIG. 1b is a schematic representation of the access method according to the invention,

FIG. 2 is a representation of a composite graph modeling an organized database build by the organization method according to the invention and accessible by the access method according to the invention;

the FIG. 3a is a representation of a query according to the access method in the form of graph applicable to the graph of FIG. 2;

the FIG. 3b is a representation of a graph-query according to the access method of the invention;

the FIG. 3c is a representation of a graph-query of FIG. 3b with constraints applied;

the FIG. 3d is a representation of a second graph-query according to the access method in the form of a graph applicable to the graph of FIG. 2;

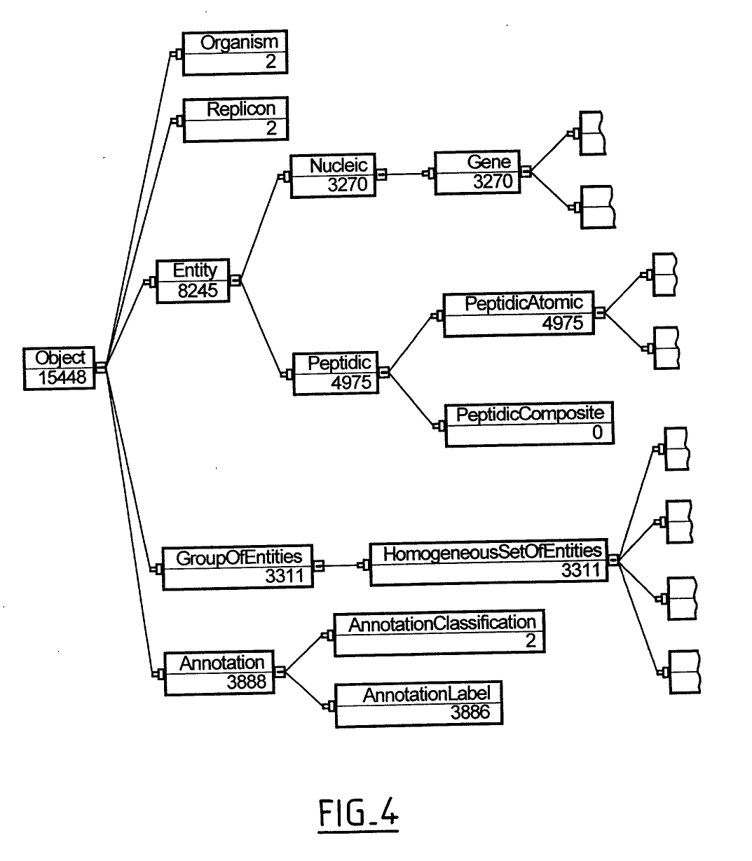

the FIG. 4 is a representation of the hierarchy of the types of data nodes of the organized database;

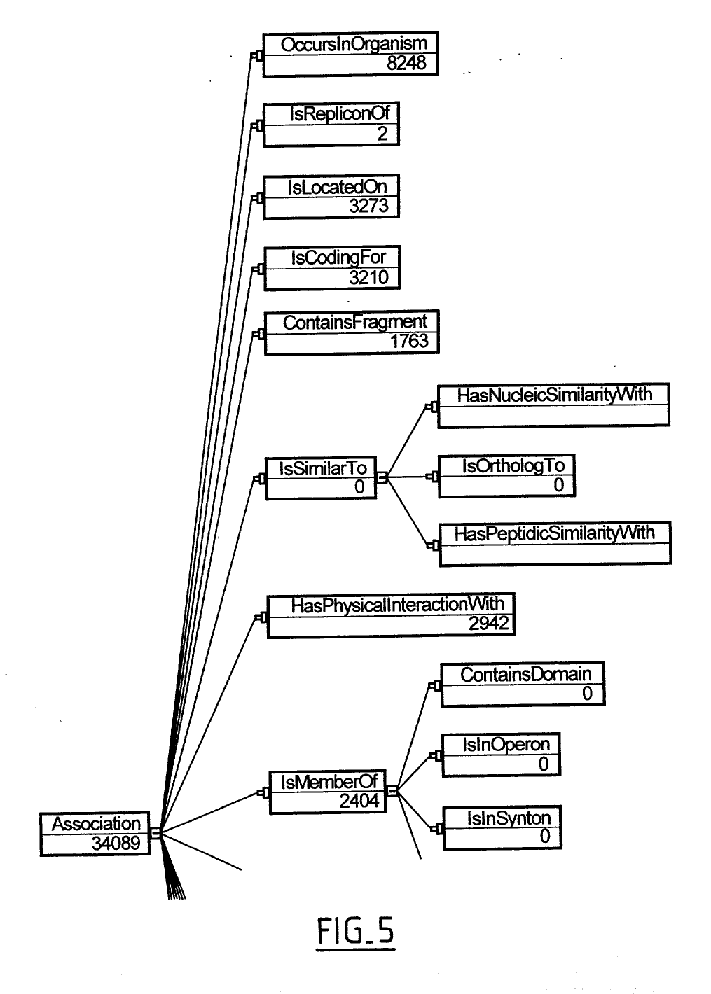

the FIG. 5 is a representation of the hierarchy of the types of links ready to bind at least two data nodes of the organized database;

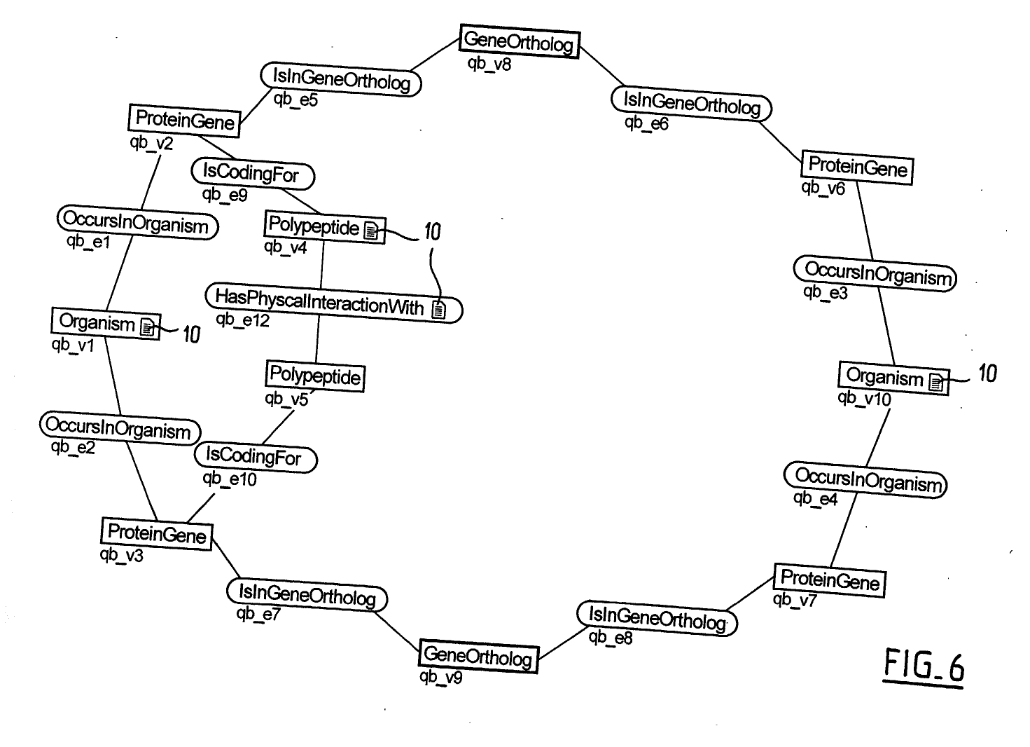

the FIG. 6 is a representation of a graph-query according to the access method of the invention;

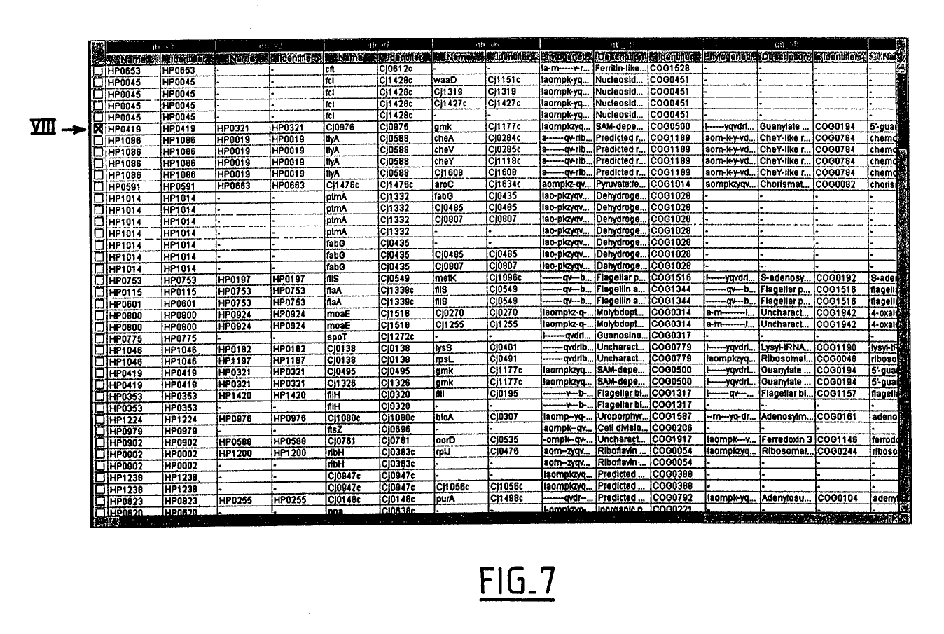

the FIG. 7 is a table showing an extract of the results obtained by the access method according to the invention following the execution of the graph-query of FIG. 6;

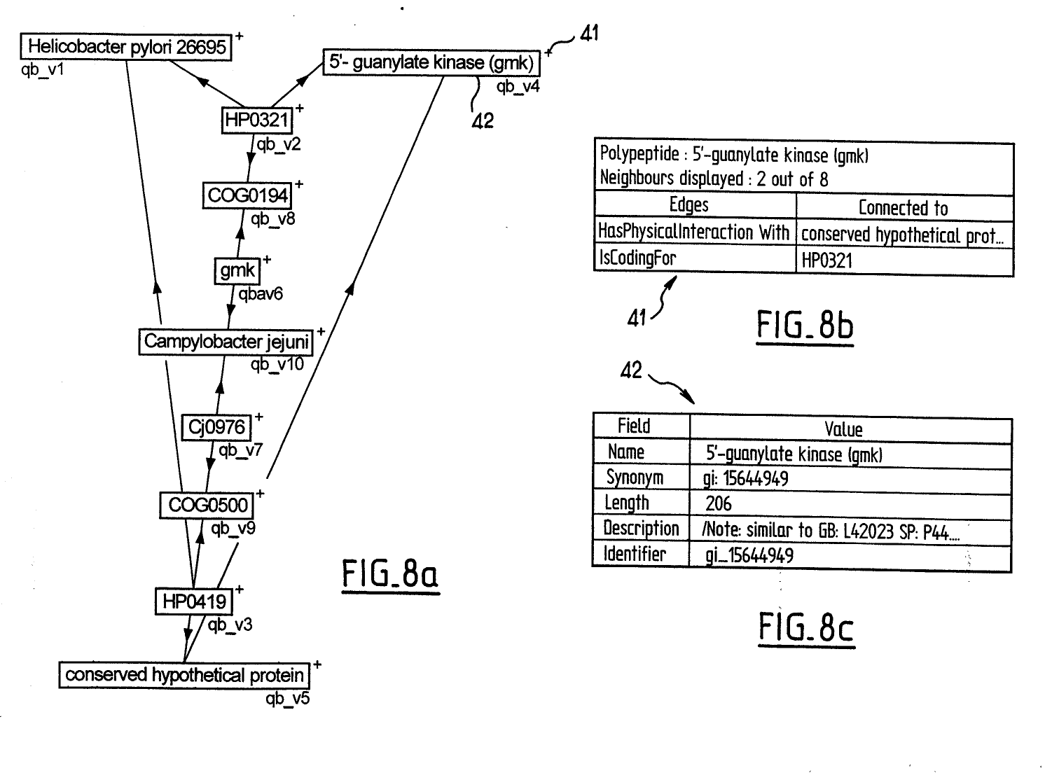

the FIG. 8a is a representation of a graph-result illustrating a result line of the table of FIG. 7;

the FIG. 8b is a showing table of the neighbors of a node of the graph-result of the FIG. 8a; and,

the FIG. 8c is a table showing the attributes and their values for a node of the graph-result of the FIG. 8a.

In reference to FIG. 1a, the organization method 100 gathers from a plurality of independent databases 110 a mass of information concerning one or more genomes. For example, one of the Independent databases 100 gives interaction information between proteins. Another one gives domains information, still another one gene information, etc . . . The independent databases are generally store on distant servers or local computer capable to be reached through a network, as Internet for example.

The organization method 100 creates with the mass of information gathered a database 2. The said method 100 organized the database as follow, in a preferential way: the organization method 100 determines from the mass of information thus gathered a set of data node types with biological entities/concepts information and a set of link types with biological links/interactions information. Then the method organizes in a hierarchical way the set of data node types and the set of link types as illustrated in FIGS. 4 and 5. After, the method organizes the mass of information thus gathered in a plurality of data nodes and a plurality of links associated with their respective data node or link type previously organized. Then, the organization method stores in tile organized database 2 the hierarchical organized sets of data node types and of link types and the mass information organized in the plurality of data nodes and links.

In a preferential way, the database 2 presents a set of data that can be modeled in the form of a mixed composite graph. It is said that the graph is composite because it consists of nodes and links being able to be of different natures. Indeed, each node, like each link, has a specific type, as it will be seen below. It is also said that the graph is mixed because it comprises edges (which are not-directed links) and arcs (which are directed links) connecting nodes two by two.

Each node (a1, b1, b2 . . . ) of graph-data 20 (FIG. 2) represents a biological entity (for example a gene, an enzyme, a chromosome . . . ), a concept (for example a metabolic cycle, a function . . . ) or a group of nodes (for example a group of ortholog genes). Each node comprises a single identifier and can comprise one or more attributes. The set of the graph-data nodes types is organized in a hierarchical way according to a tree as illustrated in FIG. 4. Each node of the tree is a graph-data nodes type capable to be represented within the graph-data. The relations between the nodes of the tree are simple relations father/son. For example, the “peptide” type of graph-data nodes is:

the son of the graph-data nodes type “entity”, itself son of the generic graph-data nodes type “object”, and

the father of graph-data nodes type “atomic peptide” and of the graph-data node type “peptide composite”.

This relation father/son implies that the son inherits all the attributes of the father

With regard to the connections between the nodes of the graph given, each link (r1, r2, g1, g2 . . . ) represents a biological link between two nodes. In a preferential way, these links are binary: each link connects two nodes between them exactly. As indicated previously, one distinguishes two links:

edges which are not-directed or symmetrical links for which the two nodes thus connected play a similar role and can be, thus, interchanged. This implies that the two nodes thus connected are of the same way type.

the arcs which are directed links for which one of the two nodes thus connected is regarded as the “source node” and the other like the “target node”. The two nodes are not interchangeable and can be of different types.

As for the nodes, a link comprises a single identifier and can comprise one or more attributes. The set of the links types is organized, it also, in a hierarchical form of a tree (FIG. 5). Each node of this tree is a links type capable to be represented within the graph-data. As previously, the relations between the nodes of this tree are of father/son type, implying that a son inherits all the attributes of his father.

In addition and in a preferential way, the types of the nodes connected by a link of a link type can “be overloaded”, i.e. be redefined on the level of each link of the graph-data. However, the hierarchies of the nodes types and links types must remain coherent by complying with the following rule: if a link of L type connects a node of A type with a node of B type, all the links types, sons of the L type must connect nodes types sons of A and B types respectively, and all the nodes of the type son of the A and B type respectively can be connectable by a link of the L type (or by a link of the type son of the L type).

We are going to describe the access method capable of accessing by query the previously described database.

In reference to FIG. 1b, the access method according to the invention is capable to treat a query 3 by extracting the data answering the said query of the database 2, so as to provide a set of answers 4.

As we have seen, the database 2 is a database whose organization of the data is representable in the form of a graph as illustrated in FIG. 2 and build by the previous described organization method.

In the same way, the query 3 is representable in the form of another graph as illustrated in FIG. 3a or 3d.

The principle of the access method according to the invention is to seek within the graph modeling the database 2, all the patterns (or subgraphs) similar to the graph of query 3. The set of answers 4 is a list of one or more subgraphs of the graph modeling the database 2, identical to the graph of query 3.

In reference to the FIGS. 3a-d, we will describe the constitution of a query and its implementation by the access method according to the invention.

Illustrated in FIG. 3a, a query 30 is appeared as a related mixed composite graph representing a pattern of graph-data.

The access method according to the invention will seek all the possible occurrences of this pattern in the graph-data given previously described. The various nodes composing this pattern (or graph-query) are nodes types such as defined in the tree of the nodes types previously described of the database that the access method according to the invention will query during the execution of the graph-query. Constraints can be defined on one or more attributes of the type of node considered.

In the same way, the various links composing the graph-query are links types such as defined in the tree of the previous links types of the database that the access method according to the invention will query during the execution of the graph-query. In this case also, constraints can be defined on one or more attributes of the type of link considered.

The example of graph-query of the FIG. 3b represents the loosest possible type of graph-query. Indeed, it includes only types constraints (links and nodes) without constraints defined on attributes of these types. The types constraints are the loosest constraints being able to be integrated in a query. The said graph-query of the FIG. 3b respectively comprises two nodes of the type “organism” linked to two nodes of the type “Protein” by a directed link of type “location”, the two nodes of the type “Protein” being linked between them by a not-directed link of type “Proteic similarity”. This graph-query makes it possible to seek all the couples of organisms containing at least a protein having a certain similarity two by two.

In the example illustrated in FIG. 3c, constraints on attributes were added to the graph-query of the FIG. 3b in order to restrict the number of results. In this case, the first node of the type “organism” is restricted at the organism having as name “H.pylori”, whereas the second node is restricted at the organism named “E.coli”. The two nodes of the type “Protein” have the same constraint on their length attribute (<500) and the link of the type “proteic similarity” must have a score<0.4.

It is thus to note that, on each object forming the graph-query, the user can impose local constraints:

logic of type (for example, a node is of type “protein”, a link is of type “proteic similarity”). It is the loosest constraint;

logic and/or arithmetic on the values of attribute (for example, score<0.4, name=“E. coli”); and,

of connectivity, for the links only, inherent of the structure describing the nodes and links types of the graph-data: these constraints define a topology of the graph-query.

Moreover, in an optional way, it is possible to formulate global constraints on a set of nodes and/or links attributes, for example “the sum of the attributes “score” of these n links types “proteic similarity” is lower than 0.8”.

In a practical and preferential way, a formulation of the graph-query consists in describing its components (nodes/links) with variables of nodes/links. Considered in a separated way, each variable indicates a set of occurrences of nodes or links in the graph-data satisfying the possible constraints of the said variable. Thus, this set can be empty, either contain only one or several occurrences. The set of the variables thus defined represents the graph pattern whose access method according to the invention will seek all the occurrences (graphs-result) in the graph-data. It should be noted, that, preferentially, to a variable of the graph-query only one occurrence of node or link in a graph-result can correspond.

In a preferential way, the description of the graph-query can be carried out in the form of a script gathering all the definitions of the variables and their possible constraints on attribute. For that, the structure of these definitions is as follows:

a variable of the nodes type is defined by:

name_var_nodes isa nodes_type [where conditions];

a variable of the links type is defined by:

name_var_links (name_var_nodes_target) isa links_type [where conditions];

where conditions comprises the set of the possible constraints on attributes associated the type of nodes/links defining the variable considered.

It should be noted that type could be a Boolean expression of types. For example, one can define a variable of the nodes type by:

name_var_nodes isa ((type1 and type2) and not (type3 or type4)) [where conditions];

Thus, the graph-query of the FIG. 3b can be described by the script:

o1 isa Organism;

o2 isa Organism;

p1 isa Protein;

p2 isa Protein;

11 (p1, o1) isa Location;

12 (p2, o2) isa Location;

ps (p1, p2) isa ProteicSimilarity;

And that of the FIG. 3c by the script:

o1 isa Organism where Name==“E.coli”;

o2 isa Organism where Name==“H.pylori”;

p1 isa ProtQin where Length<500;

p2 isa Protein where Length<500;

11 (p1, o1) isa Location;

12 (p2, o2) isa Location;

ps (p1, p2) isa ProteicSimilarity where Score<0.4;

The graph-query being defined and being represented by a set of variables, we now will describe how the access method according to the invention executes, on the graph-data, the graph-query. For that, one will refer to FIGS. 2 and 3a.

Graph-query 30 is represented by five variables: three variables of nodes c, b, and b′ and two variables of links g and g′.

In a first step, the access method determines the links variable representing fewer occurrences in the graph-data. In this case, the number of occurrences of g and g′ is equal to 7. When there is equality, the access method according to the invention chooses, in a preferential way, the first defined variable, here g.

The variable thus determined is the trailer variable because it is used as a starting point to get going on the query.

Then, in a second step, the access method seeks a set of occurrences corresponding to subgraph-query b-g-c. The result is as follows:

TABLE 1

| occurrence | b | q | c |
|---|---|---|---|
| 1 | b1 | G3 | c1 |
| 2 | b2 | G2 | c1 |
| 3 | b3 | G8 | c6 |
| 4 | b4 | G7 | c5 |
| 5 | b5 | G6 | c4 |
| 6 | b6 | G5 | c3 |
| 7 | b7 | G4 | c3 |

Then, in a third step, the access method according to the invention considers the set of the links variables having one their nodes present in previous subgraph-query.

The access method does not consider the variables of links already present in previous subgraph-query. Again, among this set of variables of links considered, the access method chooses, as previously, the variable representing less occurrences in the graph-data. In the event of equality, it is the first defined variable that it chooses.

In the illustrative case of the FIG. 3a, the variable of node b does not comprise other connection that the one represented by the variable of link g, whereas the variable of node c comprises a new connection represented by the variable of link g′. Therefore, the access method chooses the variable g′ to continue the query.

The access method seeks then starting from previous table 1 all the occurrences corresponding to the new subgraph-query (b-g-)c-g′-b′, which is being here the starting graph-query.

The first line of the previous table 1, the access method finds:

TABLE 2

| occurrence | b | g | c | g′ | b′ |
|---|---|---|---|---|---|
| 1 | b1 | g3 | c1 | g3 | b1 |
| 2 | b1 | g3 | c1 | g2 | b2 |

And so on for each line of table 1.

The result of search gives finally eleven authorities:

TABLE 3

| occurrence | b | g | c | g′ | b″ |
|---|---|---|---|---|---|
| 1 | b1 | g3 | C1 | g3 | b1 |
| 2 | b1 | g3 | C1 | g2 | b2 |
| 3 | b2 | g2 | C1 | g3 | b1 |
| 4 | b2 | g2 | C1 | g2 | b2 |
| 5 | b3 | g8 | C6 | g8 | b3 |
| 6 | b4 | g7 | C5 | g7 | b4 |
| 7 | b5 | g6 | C4 | g6 | b5 |
| 8 | b6 | g5 | C3 | g5 | b6 |
| 9 | b6 | g5 | C3 | g4 | b7 |
| 10 | b7 | g4 | C3 | g4 | b7 |
| 11 | b7 | g4 | C3 | g5 | b6 |

As to each variable of a graph-query only one occurrence of node or link in a graph-result can correspond, the graph-query of the FIG. 3d is not equivalent to the one of the FIG. 3a. Indeed, for the graph-query of the FIG. 3a, the access method seeks three occurrences of node and two occurrences of link for each graph-result: an occurrence of c connected to an occurrence of b via an occurrence of g and to an occurrence of b′ via an occurrence of g′. For the graph-query of the FIG. 3d, the access method seeks two occurrences of node and two occurrence of link for each graph-result: an occurrence of C connected to an occurrence of b via an occurrence of g and an occurrence of g′. It should be noted that the graph-query of the FIG. 3a includes the graph-query of the FIG. 3d: indeed, if one adds the global constraint b=b′ to the graph-query of the FIG. 3a, one obtains the graph-query of the FIG. 3d.

In a general way, the access method according to the invention repeats the third step until having executed the whole graph-query.

It should be noted that the choice of the trailer variable can be imposed by the user. In the same way, the user can as impose the use order of the variables of links starting from the trailer variable, by paying attention, preferentially, as at least an occurrence of the variable of link of row N presents a node in common with one of the occurrences of one or the variables of link of row 1 to n−1.

Within the script previously quoted, the initialization of a query can be defined, just after the variables definitions, by:

query name_var_query list_var_links_defined [where global_conditions];

where list_var_links_defined can be a simple list of variables of the links type separated by a comma (for example: 11, 12, ps) or an ordered list of variables separated by a semi-colon (for example, 11:ps:12). In the second case, the ordered list imposes the trailer variable (11) and the use order of the following variables (then ps then 12) that the access method according to the invention must considered executing the graph-query defined by the script.

Then the request is launched by a following function of the type:

create name_graphs_result from name_graph_data with name_var_query;

In FIG. 6, a example of a graph-query is illustrated. The nodes of the graph are represented by rectangles and the links of The graph by rectangles with rounded corners. The name of The associated variables is indicated: qb_vX for a node and qb_eX for a link.

The graph-query can be interpreted as follows:

an organism qb_vl comprises two protein genes qb_v2 and qb_v3 respectively coding two polypeptides qb_v4 and qb-v5 presenting a physical interaction qb_el2. Moreover, protein gene qb_v2 belongs to the family of the ortholog genes qb_v8 whereas the protein gene qb_v3 belongs to the family of ortholog genes qb_v9; and,

one also seeks a organism qb_v10 comprising two protein genes qb_v6 and qb_v7 belonging to the families of ortholog genes qb_v8 and qb_v9 respectively.

Constraints 10 on attributes were defined on certain nodes; the name of the organism qb_v1 is defined as the one of the organism qb_v10 for example. Attributes were also constrained for polypeptide qb_v4 and the link qb_e12.

The access method according to the invention carries out the graph-query as previously described, and provided the table of result of FIG. 7.

In FIG. 8a is represented a graph-result illustrating one of the lines of the table of FIG. 7.

With each node 42 of the graph-result a pictogram 41 is associated, here a cross “+”. The presence of this pictogram indicates to the user the presence of “neighbors” other than those present directly on the graph-result.

In this case, the neighbors, illustrated in FIG. 8b, of the occurrence named “5′-guanylate kinase (gmk)” of the variable qb_v4 are eight of which two are indicated in a table mentioning the type of link and the target node thus connected.

By selecting pictograms 41, the user enriches the original graph-result thus and allows him to complete the initial results by widening the search.

For that, the access method according to the invention displays only the pattern of the graph-result resulting from the execution of the graph-query, the connections with the remainder of the graph-data being illustrated by pictograms 41. They give access to the neighbors closest to the displayed nodes.

In addition, for each node 42, the set of the attributes is accessible, preferably, in the form of a table illustrated in FIG. 8c, here the attributes of the occurrence named “5′-guanylate kinase (gmk)” of the variable qb_v4.

The access method 1 according to the invention can be implemented, in a preferred way, by a processor connected to memorization means capable of memorizing the graph-modeled database 2. The query 3 is formed via input means useable by the user. The set of results 4 to the query is displayed on display means after computation by the processor. In a preferred embodiment, the processor, the memorization means, the input means and the display means are parts of a standalone computer like a PC (Personal Computer, a laptop, a standalone workstation, a PDA (Personal Digital Assistant), etc . . . ).

In another embodiment, the graph-modeled database is stored in the memorization means of a server connected to a network (local network, internet, etc . . . ). A client comprises the input and display means and is connected to the network in order to be capable to connect to the said server. The processor that implement the access method according to the invention can be:

part of the server, the query is computed by the server; or,

part of the client, the query is computed by the client.

Of course, one will be able to make to the invention many modifications without leaving the scope of this one.

1. Method to organize genomic and proteomic information in a organized database having a plurality of data nodes and a plurality of links capable to bind data nodes two by two, genomic and proteomic information being stored in a plurality of independent databases, the method being capable to be implemented by a processor capable to access a plurality of memorizing means containing the plurality of independent databases respectively and to storage means containing the organized database, wherein the method comprises steps of:
a) gathering data from the plurality of independent databases concerning at least one genome,
b) determining from the data thus gathered a set of data node types with biological entities/concepts data and a set of link types with biological links/interactions data,
c) organizing in a hierarchical way the set of data node types and the set of link types,
d) organizing data thus gathered in the plurality of data nodes and the plurality of links associated with their respective data node or link type,
e) storing in the organized database the hierarchical organized sets of data node types and of link types and organized data.

2. Method according to claim 1, wherein, in step c, each type presents at least one attribute.

3. Method according to claim 2, wherein, in step c, a child type inherits of all the attributes of his father type.

4. Method according to one of the claims 1 to 3, wherein, in step c, a root type is created comprising a set of attributes common to all other type in the considered set.

5. Method according to one of the claims 1 to 4, wherein, in step c, a father type is created for a group of child types having a set of attributes in common.

6. Method according to one of the claims 1 to 5, wherein, in step d, two data nodes of a first and a second data node types respectively connected by a first link of a first type link are capable of being connected by a second link of another second link type.

7. Method accorded to claim 6, wherein the second link type is a son or a father of the first link type.

8. Method accorded to one of the claims 6 to 7, wherein two data nodes of types sons of the first and the second data node types respectively are capable of being connected by a link of the first link type or of a type son of the link type.

9. System comprising a processor capable to access a plurality of memorizing means containing the plurality of independent databases respectively and to storage means containing the organized database, characterized in that it is capable to implement the method according to one of the claims 1 to 8.

10. Access method to access by query, from a data consultation terminal, to the contents of a database organized by an organization method according to one of the claims 1 to 8, the access method being capable to be implemented by a processor capable to access memorizing means containing the database, wherein the access method comprises, for a defined query, steps of:
a) organizing of the query in the form of a graph pattern comprising a plurality of nodes and a plurality of links binding the nodes two by two, the nodes and the links being taken in the set of data node types and links types respectively of the organized database;
b) seeking in the database of a set of nodes and links whose type corresponding to the said query thus organized, the said set of nodes and links forming a set of occurrences of the graph pattern;
c) provisioning the terminal with the said set of nodes and links.

11. Method according to claim 10, wherein, in step b), the method comprises the following steps:
b1) determining a graph sub-pattern of the graph pattern comprising only one link binding two nodes, the link being selected among the plurality of links of the graph pattern;
b2) searching in the organized database a set of occurrences of the graph sub-pattern thus determined;
b3) selecting a link among the possible links binding the nodes of the previous graph sub-pattern to nodes of the graph pattern not comprised in the previous graph sub-pattern;
b4) determining a new graph sub-pattern comprising the previous graph sub-pattern, the link sought at the time of the previous step and the node that this link connects to one of the nodes of the previous graph sub-pattern;
b5) searching in the organized database of a new set of occurrences of the new graph sub-pattern thus determined from the previous set of occurrences;
b6) while the new graph sub-pattern is not the graph pattern, repeating the steps b3 to b5, the new graph sub-pattern becoming then the previous graph sub-pattern and the new set of occurrences, the previous set of occurrences.

12. Method according to the claim 11, wherein, in step b1), the link being selected has the lowest number of occurrences of links in the organized database.

13. Method according to the claim 11 or 12, wherein, in step b3, the link selected has the lowest number of occurrences of links in the organized database.

14. Method according to on of the claims 10 to 13, wherein, in step a), each node of the graph pattern is modeled by a variable exclusive to said node.

15. Method according to one of claims 10 to 14, in stop a), each link of the graph pattern is modeled by a variable exclusive to said link.

16. Method according to claims 14 and 15, wherein the exclusive variable of link is associated in an indissociable way to two variables of nodes modeling the two nodes of the graph pattern bound by the link modeled by the variable of link considered.

17. Method according to one of claims 10 to 16, wherein the query is directly defined in the form of a graph pattern.

18. Method according to one of claims 10 to 17, wherein, in step c), the provision is carried out in the form of a table of data nodes and links whose each line corresponds to an occurrence in the organized database of the graph pattern.

19. Method according to one of claims 10 to 18, wherein, in step c), for each occurrence of the graph pattern found, the method enriches the data of the occurrence considered by indicating the existence of possible data nodes of the organized database, called neighbors, connected directly to the data nodes of said occurrence.

20. Method according to claim 19, wherein, during enrichment, the method indicates for each data node of the occurrence considered, the number of possible neighbor data nodes.

21. Method according to claim 20 wherein the method indicates, for each possible neighbor data nodes, information concerning the link that connects it to the data node considered of the occurrence considered.

22. System comprising a processor capable to access memorizing means containing the database, characterized in that it is capable to implement the method according to one of claims 10 to 21.
